(19) United States
(12) Patent Application Publication
(10) Pub. No.: US 2009/0134640 A1
(43) Pub. Date: May 28, 2009

(54) StopGuard

(76) Inventor: Chance Wayne Ruffino, Houston, TX (US)

Correspondence Address: CHANCE W. RUFFINO, 13106 ASTE LANE, HOUSTON, TX, 77065, US

(21) Appl. No.: 11/998,040

(22) Filed: Nov. 28, 2007

(51) Int. Cl. E05C 17/44

(52) U.S. Cl. 292/338

(57) ABSTRACT

StopGuard is a creative and new in-site, in the residential security demand for better and more effective alternatives in the safeguarding of life safety, as well as the protection of personal property. In addition, StopGuard will introduce the industry to a new method of anti-intrusion. Not to exclude other applicable situations that the StopGuard device may be implemented or used to accomplish its clear advantage of resistance, deterrence, and stopping capabilities by integrating the strength and integrity of the strongest and closest (as reference to proximity) access going in and out of the home. StopGuard will accomplish this task by a combination of unbreakable hardware in association with the concrete or other floor material to successfully protect the occupants of the home from unlawful entry. StopGuard, when in place, will block the door and provide invaluable protection with the new concept of integrating an alternative place for protecting the home.

### CROSS-REFERENCE TO RELATED APPLICATIONS

Provisional patent application No. US60/861,057

### STATEMENT REGARDING FEDERALLY SPONSORED RESEARCH OR DEVELOPMENT

Not Applicable

### REFERENCE TO SEQUENCE LISTING, A TABLE, OR COMPUTER PROGRAM LISTING COMPACT DISC APPENDIX

Not Applicable

### BACKGROUND OF THE INVENTION

StopGuard represents, in name and in design, the function of its inherent representation to “Stop” intruders, criminals, or any other individuals whom do not have legal entitlement to the home. In addition, this invention will “Guard” life, property, and provide a needed sense to have piece-of-mind, and the serenity that has been lost over the last decade.

As forced entry into the various dwellings of persons whether they be at work, home, elderly, or any other persons who currently are faced with the limited choices provided to deter and stop this illegal activity. A matter that has slipped our attention in numerous statistics and data obtained, has illustrated a need for better and more creative ways to feel safe. A StopGuard owner will have the power to denying entry with minimal effort.

In conclusion, StopGuard is a supplemental security item that, with the other necessary security precautions such as around windows and other avenues of entry, will solidify the efforts of the homeowner to protect and/or alert them as necessary with time, to provide safe distance, and request professional law enforcement help.

### BRIEF SUMMARY OF THE INVENTION

By introducing StopGuard, a new and innovative security device, I am denying passage through the various doors of the home and living space. I intend to show that StopGuard will integrate the strength of the floor to eliminate the undesired traffic in and out of the residence, as opposed to the existing method accepted by the industry of using the wooden door frame. This application is plausible in current and new home construction for all doors that have an inward swing. The trend demand for this inward swinging door is the new standard for construction because of the previous consequences of doors with an outward swing relative to undesired entry.

Notwithstanding the above mentioned application of use, StopGuard will be applicable in other outside instances in relation to the security of doors and access in general such as commercial or industrial situations whereas access is to be restricted or maintained.

### BRIEF DESCRIPTION OF THE SEVERAL VIEWS OF THE DRAWINGS

FIG. 1: An aerial view of the device, two inches in diameter, made of a polished steel or other reflective plating for a high visibility effect. The overall body head of the device, #2, can also be seen in FIG. 2. The name “StopGuard” #1, will be engraved and painted as well as, #3, “LIFT TO REMOVE” providing instructions for the user when the device is in place to return access through the door.

FIG. 2: A front/side view of the StopGuard security deterrent device illustrated here being one piece polished, hardened steel including two parts; the Head, #5, and the Peg, #6. The Head, #5, is four inched tall and two inches wide. The Peg, #6, is three inches long and a half inch wide. The Peg Tip, #7, is tapered and blunt. The groove represented in #4 is intended for the O-ring (FIG. 7 #13) used to defuse/absorb forced impact. The Head, #5, references the entire cylinder from top, #2, to bottom, and #8. The concaved bottom, #8, will mate with the Flange (FIG. 5 #11) having a convexed surface.

FIG. 3: A sectional view of the StopGuard device representing one hardened piece of steel throughout, #9, for manufacturing perfection

FIG. 4: An aerial view of the Flange, #9, two inches in diameter, and is produced from similar metals as used in the other StopGuard components. The designated space, #10, is the provided housing, also seen in FIG. 5 #10, for the Peg (FIG. 2 #6).

FIG. 5: A front/side view of the Flange Peg Case, #12. The Flange surface is convexed, #11, being two inches in diameter, and mates with the concaved bottom of the Head (FIG. 2 #8). The Peg Case, #12, is three inches long and will exist under the floor.

FIG. 6: A sectional view of the housing thickness and the Peg Case, #12, depicting how it exists under the floor.

FIG. 7: The complete StopGuard assembly. All three components are represented in order of placement to make active. The installation of the O-ring, #13, placed over the Head, #2, and fitting into the O-ring Groove, #4, while the Peg, #6, rests within the housing of the Flange Case, #12.

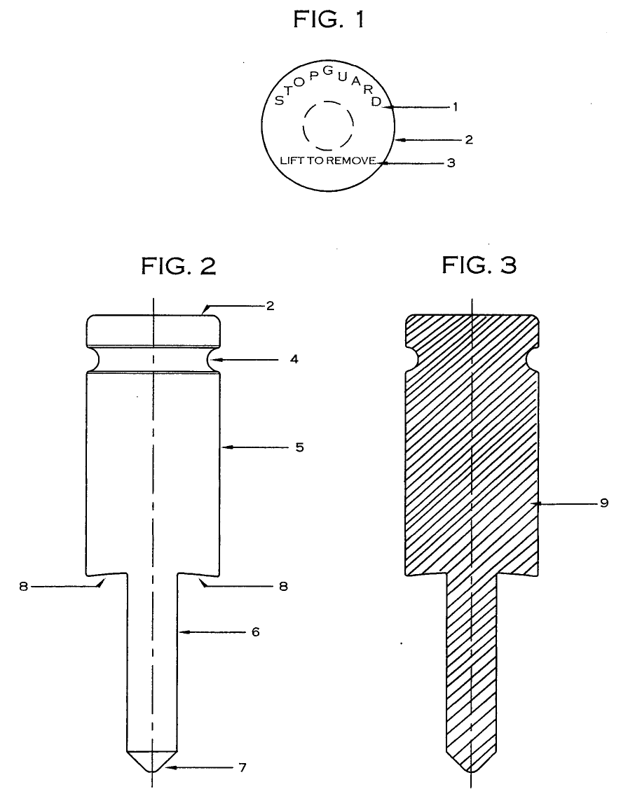

### DETAILED DESCRIPTION OF THE INVENTION

In this section the invention StopGuard has materialized from a fundamental need of better options in the curtailment or deceasement of illegal entry of the home by those who threaten our lives and safety. This section will also show the industry standard for accomplishing the security of the residential home has been limited by a combination of the ratio between cost and aesthetic value to provide the ordinary homeowner with a viable solution for this problem.

The current tumbler locks, chains, deadbolts, and various others have a common technical flaw. This flaw can be found in the area of the door by the insufficient strength of the door jam to act as the only location for these devices.

The materials and technology for the StopGuard security device are within the limits of manufacturing with a minimum cost passed on to the consumer. In the drawings we have professionally illustrated the various views required for the machining, reproduction, elements of steel works and rubber O-ring, #13, makers needed to produce this device for pre-existing homeowners as well as future new construction home builders.

The StopGuard security system will integrate the strength and integrity of the concrete slab common in homes. In addition, the security system will be available to other individuals having other than concrete slab applications with added accessories deemed necessary in order to gain the same integral strength as concrete. This will be achieved by the StopGuard being mounted in the floor within the angle swing of the door.

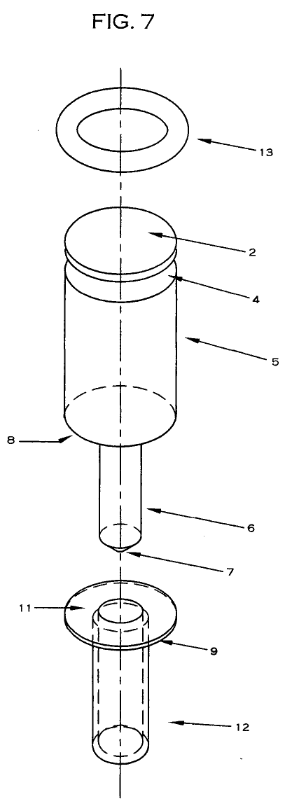

Every component will have a polished reflective exterior and a solid steel interior produced by mold or dye cut with the exception of the rubber O-ring. I feel any machine shop could produce the Flange, FIGS. 5 & 6, and Head, FIG. 2, with ease. The rubber O-ring, FIG. 7, #13, having standard dimensions could be ordered or produced easily as well.

The tools required for installation would be a long term epoxy resin, hammer drill with standard masonry bit used to drill a hole in the floor for Flange, FIG. 5.

I claim my invention is an affordable alternative to the assortment of door locks that draw their stopping power with ineffective materials. The StopGuard name describes the intent to stop intruders and guard ones family.

1. To protect life and property by disallowing entry.

2. To keep the door from opening when properly in place.

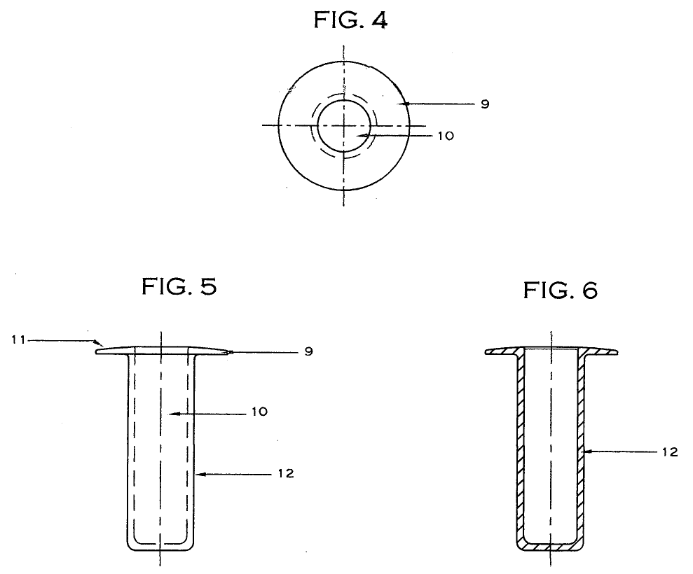

3. When the Head, FIG. 2, is not in place the convexed Flange surface, FIG. 4, and FIG. 5, #11, will make passing through the entry way less of an obstacle.

4. Easy instillation with tools obtainable at any hardware store will allow the do-it-yourselfer to install the device with minimal effort using the instructions provided.

5. The simplicity of the design and manufacturing of it will help keep cost at a minimum to allow an affordable solution to home security comparable to the cost of items currently available.

6. To provide the homeowner with ample time to contact authorities in the case of an illegal entry or disturbance without the fear of harm from the outside intruder.

7. Although easily removed, the device will prevent small children from leaving the home without notice.

8. A rubber O-ring, FIG. 7 #13, will protect the homeowner's door from damage when used; simultaneously defusing the amount of stress placed on the device.

9. The device uses the strength of the floor as a more superior location to be installed.

10. The device is not limited to a particular construction material in order to be affective.

11. StopGuard will also have an available feature for those individuals with outward swinging doors.
